(19) United States
(12) Patent Application Publication
(10) Pub. No.: US 2008/0122997 A1
(43) Pub. Date: May 29, 2008

(54) LCD based pen tablet

(75) Inventor: Andrei Cernasov, Ringwood, NJ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC.

(21) Appl. No.: 11/591,636

(22) Filed: Nov. 2, 2006

(51) Int. Cl. G02F 1/1335

(52) U.S. Cl. 349/12

(57) ABSTRACT

A liquid crystal display (LCD) device (100) having pen tablet functionality is described. An input device (200) contains a light emitter (210) at its tip. Further, a light sensing device (80) is implemented within the LCD stack to sense light passing through the liquid crystal (LC) layer (20) from the input device. As a user touches the display surface with the input device, in order to designate a particular location on the display surface, the designated location may be determined by dividing the LC layer 20 into translucent and opaque regions, as the light sensing device detects emissions from the input device.

### FIELD OF THE INVENTION

The present invention relates to a liquid crystal display (LCD) panel for use with pen tablet applications, and more particularly, to equipping the LCD panel with a sensor for detecting a location designated by a pen shaped device.

### BACKGROUND OF THE INVENTION

There are various types of user interfaces for liquid crystal display (LCD) based applications. For example, some LCD devices allow users to interact via keyboard or touchscreen. However, many types of LCD devices utilize pen tablet applications to receive user input. Pen tablet applications are intuitive. Also, pen-based interfaces are particularly useful for smaller, more portable LCD devices, e.g., personal digital assistants (PDAs).

The configuration of a typical LCD panel will now be explained with reference to FIGS. 1A and 1B. As shown in FIG. 1A, a typical LCD device 1 includes a liquid crystal (LC) layer 20 sandwiched between two polarizing filters 30A and 30B (hereafter “polarizers”). The LC layer is protected by a transparent front protective sheet 10, e.g., a glass plate. For a backlit LCD device 1, behind the LC and polarizing layers are a light diffusing film 40 (hereafter “diffuser”), a backlight source 50, and a reflective surface 60. However, in a reflective-type LCD device 1, the diffuser 40 and backlight source 50 would be omitted (thus, these layers are illustrated by dotted lines in FIG. 1A). A casing or enclosure 70 is provided to hold the aforementioned layers in place. FIG. 1B illustrates an exploded view of the stack of LCD layers described above. The specification may collectively refer to these layers as the “LCD stack” of a backlit LCD device (including diffuser 40 and backlight source 50) or a reflective-type LCD device (without diffuser 40 or backlight source 50).

Furthermore, a series of electrodes (not shown) are positioned across the LC layer 20. Particularly, by selectively applying voltages across the liquid crystal molecules in the LC layer 20, these molecules are made to “twist” in such a manner as to allow light to pass through. Thus, the electrodes (not shown) drive the LC layer 20 to display certain images by controlling the passage of light therethrough.

Generally, previous attempts to utilize a pen tablet application in conjunction with an LCD panel (backlit or reflective-type) require additional panels or layers to be added to the LCD device 1. For example, in an existing type of pen tablet application, an additional printed circuit board (PCB) provides coiled antennae beneath the LCD screen, in order to create an alternating magnetic field around the LCD screen. Movement of the pen device (stylus) across the LCD screen is sensed using the alternating magnetic field from the PCB board. However, such use of additional layers to the LCD device is disadvantageous, because it introduces unwanted interactions and noise in the LCD device, decreases brightness, increases the complexity of the resultant device, and reduces overall system reliability.

### SUMMARY OF THE INVENTION

Exemplary embodiments of the present invention are directed to a liquid crystal display (LCD) device, which is adapted for applications utilizing a stylus or pen shaped input device. Particularly, the tip of the input device includes a light emitter, and a light sensor is built within the LCD device to sense the light rays emitted by the input device. Thus, as the input device is being used to designate a particular location on the display surface (e.g., by touching the display surface with the input device), the LCD device senses light rays from the input device transmitting through the liquid crystal (LC) layer. Based on this sensing operation, the LCD device is capable of determining the location on the display surface being designated by the input device.

According to an aspect of the present invention, the LC layer may be controlled in such a way as to help track down the location being designated by the stylus or pen shaped input device. For instance, after the presence of the input device is initially detected, the LC layer may be controlled to selectively provide one or more translucent regions or “openings,” while the remainder of the LC layer is in a default state of opacity. Thus, by manipulating (i.e., changing the position, size, and/or number of) these translucent openings, and simultaneously monitoring the status of the light sensing device, the location of the tip of the input device may be narrowed down to a desired level of precision.

For instance, it is possible to control the LC layer to cause a translucent opening to scan the display surface in search for the location being designated by the input device. By taking measurements with the light sensor at each scan interval, the designated location would correspond the scan location of the translucent opening that maximizes the measured intensity.

Alternatively, the LC layer may be controlled according to a process where search areas are recursively defined within the LC layer. As each new search area is defined, the search area may cycle through a series of states in which the translucent region becomes successively smaller. By cycling through each search area through these states, the designated location is tracked down to a smaller region within the search area, and this smaller region is defined as the next search area for the next iteration of the recursive process.

According to another aspect of the invention, the LCD device may be designed to operate according to two distinct interleaved modes. These modes may include an image display mode during which the LC layer is controlled to display images on the display surface, and a “pen tablet” mode during which the LC layer is controlled (as described above) to facilitate detection of the location being designated by the stylus or pen shaped input device.

Further aspects in the scope of applicability of the present invention will become apparent from the detailed description provided below. However, it should be understood that the detailed description and the specific embodiments therein, while disclosing exemplary embodiments of the invention, as provided for purposes of illustration only.

### BRIEF DESCRIPTION OF THE DRAWINGS

A more complete understanding of the present invention will become apparent from the following description taken in conjunction with the accompanying drawings, which are given by way of illustration only and, thus, are not limitative of the present invention. In these drawings, similar elements are referred to using similar reference numbers, wherein:

FIGS. 1A and 1B illustrate the configuration of a typical liquid crystal display (LCD) device;

FIG. 2 is a block diagram illustrating the configuration of an LCD device configured for use with an light-emitting input device, according to an exemplary embodiment of the present invention;

FIGS. 3A and 3B conceptually illustrate the use of a translucent region in the liquid crystal (LC) layer in determining which location on the display surface is being designated by the input device, according to an exemplary embodiment of the present invention;

FIGS. 4A and 4B illustrate alternative patterns by which a translucent opening may scan the LC layer in order to determine the designated location on the display surface, according to an exemplary embodiment of the present invention;

FIGS. 5A and 5B conceptually illustrate a process in which the translucent portion of the LC layer is made successively smaller in order to track down the designated location to a particular quadrant of the display surface, according to an exemplary embodiment of the present invention;

FIGS. 6 and 7 illustrate how the process illustrated in FIGS. 5A and 5B may be applied recursively in order to track down the designated location to within a desired level of precision, according to an exemplary embodiment of the present invention; and

FIG. 8 is a flow diagram illustrating the steps in a recursive process for tracking down the designated location to within a desired level of precision, according to an exemplary embodiment of the present invention.

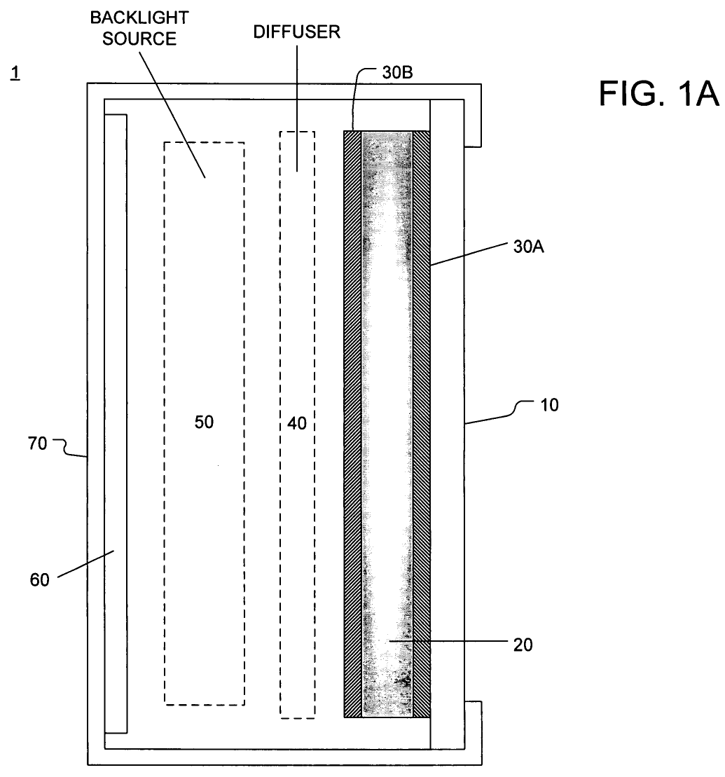

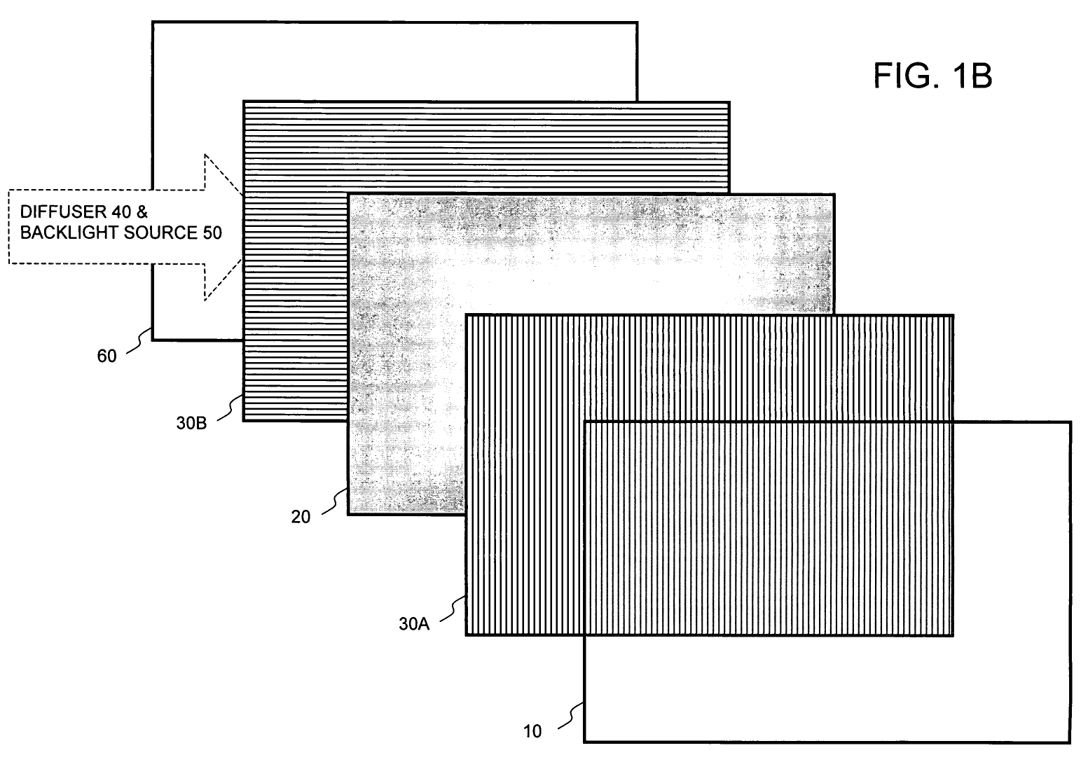

### DETAILED DESCRIPTION OF EXEMPLARY EMBODIMENTS

In order to allow users to interface with a liquid crystal display (LCD) device, the present invention utilizes a stylus or pen shaped input device, which is configured to emit light from one end (i.e., its “tip”), and a light sensing device within the stack of LCD layers for sensing the light emitted by the input device. Based on the operation of the light sensing device, the LCD device is capable of determining the location of the tip of the input device, as it touches (or nearly touches) the display surface. Thus, the LCD device is capable of determining a particular location being designated by the user via the input device.

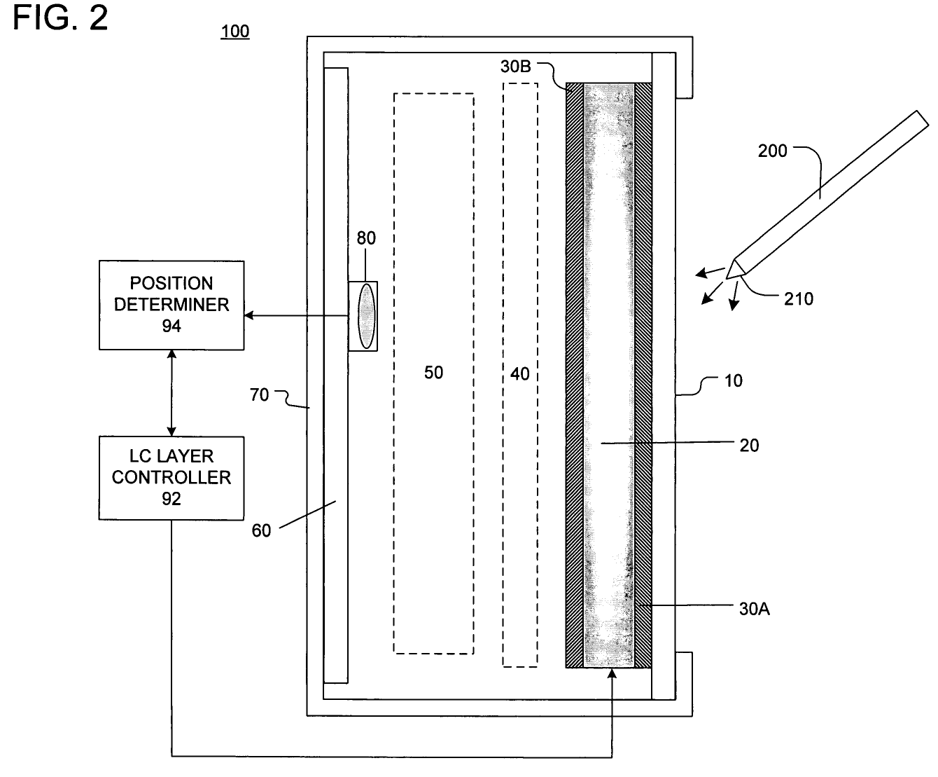

FIG. 2 is a block diagram conceptually illustrating the configuration of an LCD device, according to an exemplary embodiment of the present invention. Specifically, FIG. 2 illustrates a side view of the LCD stack in an LCD device 100, including the front surface 10, polarizers 30A and 30B, LC layer 20, and reflective surface 60. Also, since the principles of the invention are applicable to both backlit and reflective-type LCDs, the backlight source 50 and diffuser 40 are optional (as indicated by dotted lines). Within this description, reference will be made to the display surface. For the purpose of this application, the display surface may correspond to the front surface 10, i.e., the outermost layer of the LCD stack.

Furthermore, at least one light sensing device 80 is implemented within the LCD stack, behind the LC layer 20. A key feature of this particular embodiment is that the light sensing device(s) 80 is implemented behind the LC layer 20. Otherwise, the positioning of the light sensing device 80 and other elements in FIG. 2 is merely illustrative, and may be modified based on various design considerations as will be contemplated by those of ordinary skill in the art. Furthermore, while FIG. 2 illustrates a single light sensing device 80, it will be readily apparent that the number of light sensing devices 80 may be varied based on design parameters.

As shown in FIG. 2, an LC layer controller 92 is provided for controlling the LC layer 20. The LC layer controller 92 is communicatively connected to a position determining unit 94. This position determining unit 94 is configured to receive measurements or data from the light sensing device 80. Although the LC layer controller 92 and position determining unit 94 are illustrated in FIG. 2 as separate devices, their functions may be performed by a single processor, or any combination of devices as will be readily apparent to those of ordinary skill in the art.

FIG. 2 further illustrates an input device 200. As shown in this figure, the input device 200 may be a pen shaped device (also referred to as a “stylus”), which is designed for the user to point toward the display surface. As such, the user may designate a particular location on the display surface, e.g., image pixel(s), by touching that location with the end or tip of the input device 200. As illustrated in FIG. 2, the input device 200 includes a light emitter 210 at the end or tip, which is to be pointed at the display surface.

For example, the user may simulate handwriting or drawing movements on the display surface, using the input device 200, in order to continuously designate locations on the display surface. The LCD device 100 is capable of tracking the continuous movement of the input device 200 while it is touching the screen. Further, the LCD device 100 may be configured to illuminate pixels corresponding to this movement, thereby displaying the symbols or pictures drawn by the user. Thus, the LCD device 100 may operate as a type of pen tablet for the user's notes, pictures, symbols, etc.

Thus, as a matter of convenience, the operation of the LCD device 100 in detecting the location(s) designated by the user, via the input device 200, will be referred to as a “pen tablet” mode of operation. However, the use of this term is not limiting. For example, while operating in the pen tablet mode, the LCD device 100 may merely allow the user to designate singular locations on the display surface with the input device 200, e.g., pointing to checkboxes in order to choose from a plurality of menu choices.

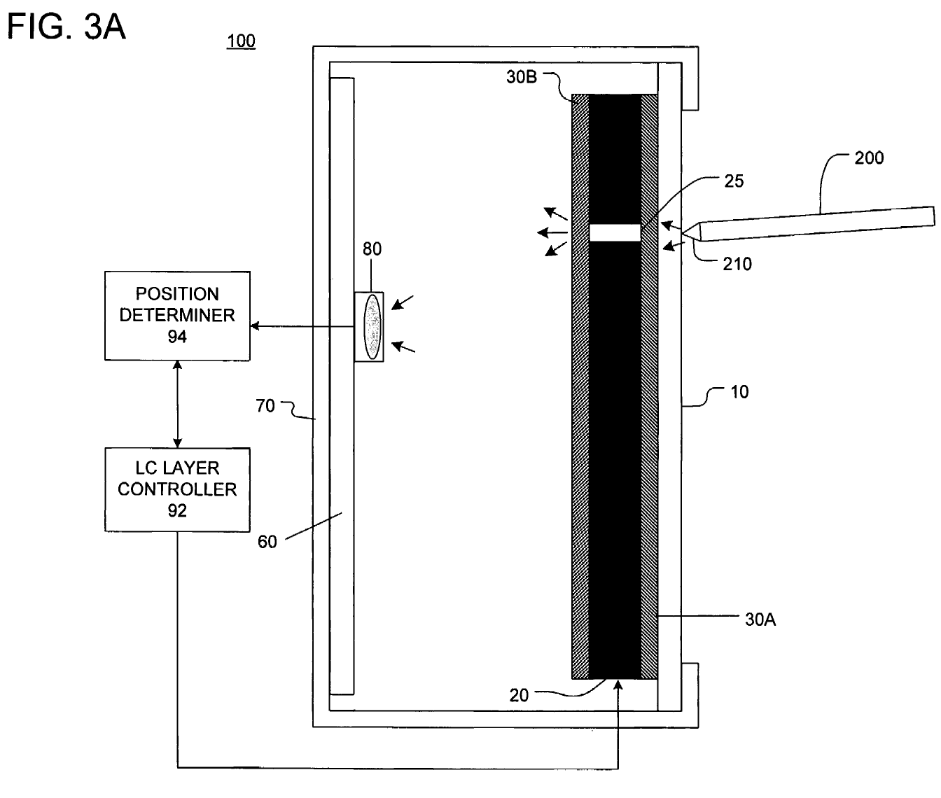

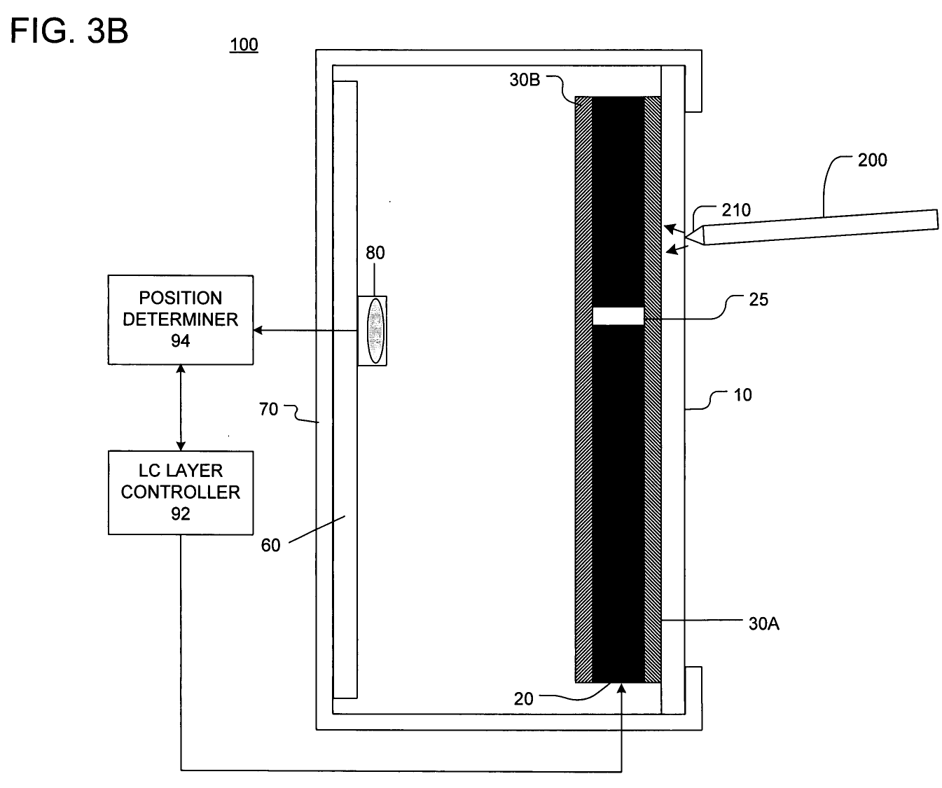

Operative principles of the LCD device 100 will now be described. To describe general principles of operation, reference will be made to FIGS. 3A and 3B. More specific embodiments will be described in relation to the subsequent figures.

According to an exemplary embodiment, the LCD device 100 may be configured for dual modes of operation, where the pen tablet mode is interleaved with a normal image display mode. Thus, the total system cycle time for the device 100 may be split into two distinct time periods: (1) a normal LCD frame period and (2) a pen tablet period.

During the normal LCD frame period (image display mode), the LCD device 100 operates to actively display an image, e.g., according to conventional techniques. Thus, during this period, the LC layer controller 92 may use conventional processes or programming for controlling the LC layer 20 to display a desired image. Also, if the LCD device 100 is backlit, the backlight source 50 is in normal operation during this period.

On the other hand, during the pen tablet period (pen tablet mode), the LCD device 100 detects whether the input device 200 is currently being used to designate a location and, if so, which location is currently being designed. Thus, during the pen tablet period, the LC layer controller 92 controls the LC layer 20 to facilitate such detection, according to principles to be described below. During this period, the position determining unit 94 and light sensing device 80 are also operative, as will be described in more detail below. Also, during the pen tablet period, any backlight source(s) 50 may be turned off to make it easier for the light sensing device 80 to sense light being emitted through the LC layer 20 from the emitter 210 of the input device 200.

It should be noted that, depending on the processing speed of the LCD device 100, the pen tablet periods may be much smaller than the LCD frame periods. Thus, a majority of the system cycle time in the LCD device 100 will be devoted to the normal image display mode. As another design consideration, the rate of interleaving between pen tablet periods and LCD frame periods should be relatively high. For example, it is contemplated that the pen tablet periods could be interleaved with the LCD frame periods at a rate of 60, 90, or 120 Hz (however, other interleaving rates could also be used).

According to an exemplary embodiment, in order to initially detect the presence of the input device 200 at the display surface during a particular pen tablet period, an operative portion of the LC layer 20 may be made translucent (i.e., optically transparent), while all other portions of the LC layer are made opaque. If the input device 200 was not detected during the preceding pen tablet period, the operative portion for the current period may be defined as corresponding to all areas of the display surface that could potentially be designated by the input device 200. However, if the input device 200 was detected during the preceding pen tablet period, the operative portion for the current period may be defined as a particular window or region surrounding the previously designated location, thus allowing the emitter 210 to be more rapidly detected/located.

As the operative portion is made translucent during the initial stage of the pen tablet period, a sensing operation is performed by the light sensing device 80 to detect whether the input device 200 is at the display surface. For example, to perform this detection, an intensity measurement may be obtained from the light sensing device 80 and compared to a threshold. If the threshold is met or exceeded, further operations may be performed by the LCD device 100 to determine the designated location, i.e., the location on the display surface where the emitter 210 is currently located.

According to an exemplary embodiment, the input device 200 may be designed to emit modulated light. Thus, the light sensing device 80 may be configured to demodulate and measure such light. For example, the emitter 210 may comprise a light-emitting diode (LED), or other type of light source, configured to emit modulated light. In order to more easily discriminate the emitted light from other light (e.g., backlight or ambient light), the emitter 210 may emit infrared (IR) light, and the light sensing device 80 may include an IR light sensor.

During the pen tablet period, if the emitter 210 of input device 200 is detected at the display surface, the LC layer 20 may further be controlled in order to determine the location being designated by the input device 200. To make this determination, the LC layer 20 may be divided into opaque and translucent regions.

FIGS. 3A and 3B conceptually illustrate the use of a translucent region in the liquid crystal (LC) layer in determining which location on the display surface is being designated by the input device 200. Particularly, these figures illustrate an embodiment in which the LC layer 20 is set to a default state of opacity, and a small translucent region 25 is provided therein. This translucent region 25 represents a portion of the LC layer 20, i.e., one or more LC cells, programmed to be optically transparent by the LC layer controller 92.

As particularly illustrated in FIG. 3A, when the position of this translucent region 25 corresponds to the location of the emitter 210 of input device 200, the light emitted by input device 200 is able to pass through the LC layer 20 and be sensed by the light sensing device 80. However, when the translucent opening's 25 position does not correspond to the location of emitter 210, light emitted by input device 200 is blocked (absorbed) by the opaque portion of LC layer 20 and, thus, not sensed by light sensing device 80.

Accordingly, as shown in FIGS. 3A and 3B, the location currently designated by the input device 200 is determinable based on the scan position of the translucent region 25 as the emitted light is sensed by the light sensing device 80. Since the position (as well as size, shape, etc.) of the translucent region 25 is controlled by LC layer controller 92, the current scan position of the translucent region 25 is available to the position determining unit 94 as soon as the light sensing device 80 senses the emission from input device 200. In this way, the position determining unit 94 may determine the location of the emitter 210, i.e., the designated location, on the display surface.

This concept of utilizing a translucent region 25 in an otherwise opaque LC layer 20 may be implemented in different ways. To illustrate this, two alternative embodiments will be described below.

In one particular exemplary embodiment, during each pen tablet period, a small translucent region 25 may be provided to scan the LC layer 20 in search for the designated location. In this embodiment, the translucent region 25 may be referred to as a translucent “opening” because its size is relatively small. Specifically, the size of the translucent opening 25 corresponds to the desired precision for determining the designated location. For instance, the translucent opening 25 may be the size of a single pixel, or on the order of a few pixels, for pen tablet applications requiring precise tracking of input device 200.

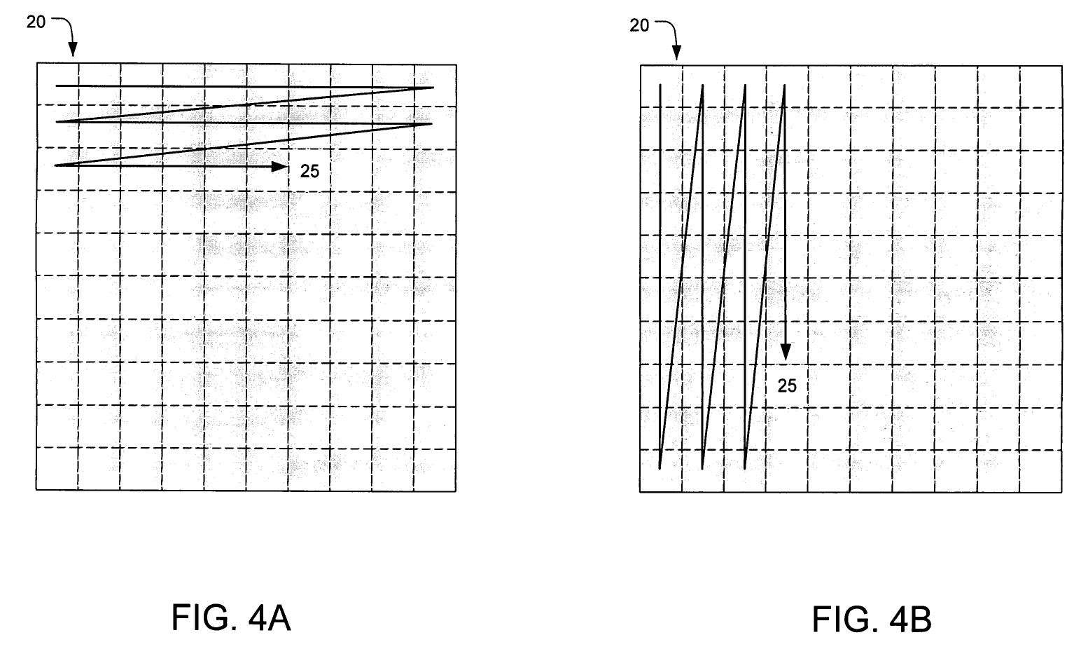

In this embodiment, during each pen tablet period, the translucent opening 25 may scan the operative portion of the LC layer 20 according to a particular scanning pattern. Examples of such scanning patterns are illustrated in FIGS. 4A and 4B. However, FIGS. 4A and 4B are provided for illustration only and, thus, other scanning patterns may be implemented.

For an embodiment utilizing a scanning translucent opening 25, it is possible to begin each pen tablet period by first making the operative portion of LC layer 20 translucent in order to sense whether or not the input device 200 is present at the display surface. If the light sensing device 80 detects the presence of input device 200 during this initial stage, the LCD device 100 may proceed to scan the translucent opening 25 to determine the designated location. However, it is not absolutely necessary to perform this initial detection stage during each pen tablet period. Another possibility would be to start scanning the translucent opening 25 at the beginning of each pen tablet period.

As described above, according to one exemplary embodiment, a translucent opening 25 may scan the LC layer 20 to search for the location designated by the user via the input device 200. However, there are other ways to determine the designated location.

For instance, according to an alternative exemplary embodiment, the LC layer 20 may be controlled through successive stages to narrow down the designated location to a particular search area. Furthermore, after a new search area is designated in such a manner, the process may be recursively applied to the new search area in order to further track down the designated location.

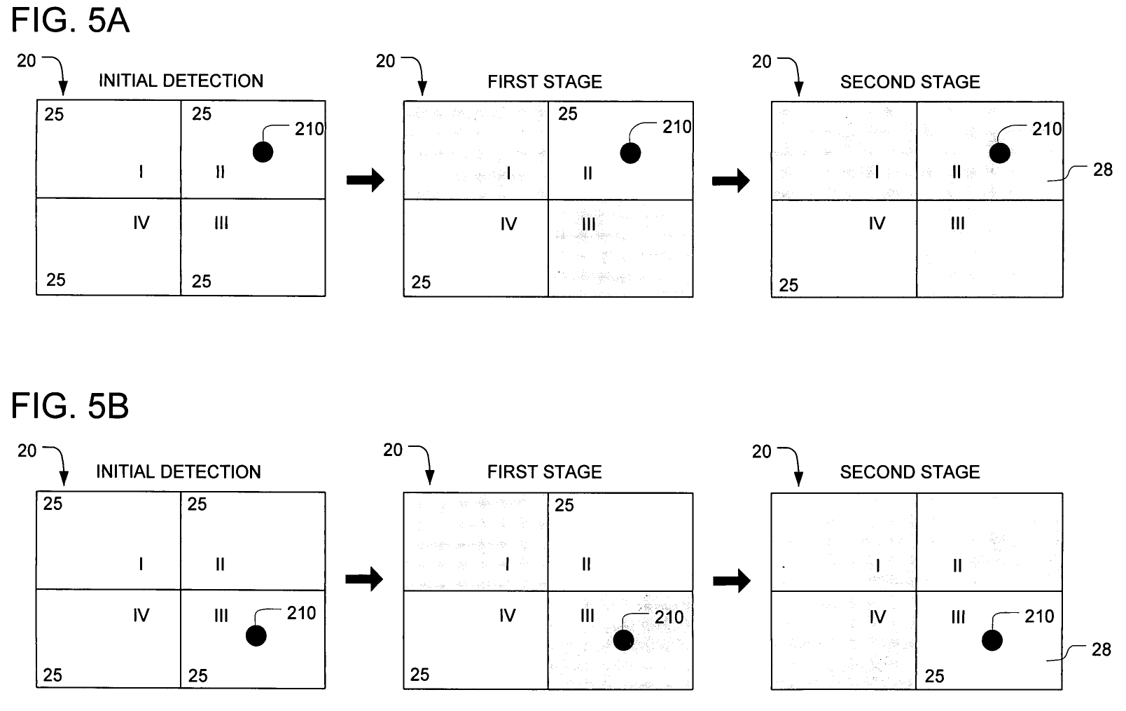

FIGS. 5A and 5B conceptually illustrate a process in which the translucent part of an operative portion of the LC layer 20 is made successively smaller in order to track down the designated location to a particular quadrant of the display surface. Particularly, FIG. 5A illustrates the process being performed while the emitter 210 is designating a location in the upper right-hand region (quadrant II) of the display surface. On the other hand, FIG. 5B shows the process being performed while the emitter is designating a location in the lower right-hand region (quadrant III).

At the beginning of a pen tablet period, the operative portion of the LC layer 20 may be logically divided into four quadrants (I-IV). As described above, the operative portion of the LC layer 20 may correspond to all areas of the display surface that could potentially be designated by the input device 200. However, if a designated location was found during the preceding pen tablet period, the operative portion may correspond to a particular region or window that is centered upon the previously found designated location.

Referring again to FIGS. 5A and 5B, initially, 100% of the operative portion of LC layer 20 is made translucent to detect whether or not the emitter 210 is present at the display surface (i.e., all quadrants I-IV are translucent regions 25). This stage is referred to as the “Initial Detection” stage in FIGS. 5A and 5B. In the particular examples of both FIGS. 5A and 5B, the emitter 210 is detected by the light sensing device 80 during the Initial Detection stage; thus, the process continues to the next stages. However, for pen tablet periods where the emitter 210 is not at the display surface, there would be no need to continue to the next stages.

As shown in FIGS. 5A and 5B, since the emitter 210 was sensed in the Initial Detection stage, the processing continues to a “First Stage” where only 50% of the operative portion is made translucent (i.e., two of the four quadrants become translucent regions 25), while the rest of the operative portion is opaque. While these figures illustrate a particular embodiment where quadrants II and IV are chosen to be translucent during the First Stage, this is merely illustrative. An arbitrary pair of quadrants could be chosen by the LC layer controller 92 to be translucent regions 25 during the First Stage.

Thus, in the First Stage, it is determined whether the light sensing device 80 still senses the presence of the emitter 210 when only two of the quadrants are translucent, in order to narrow down the operative portion to “candidate quadrants,” i.e., quadrants that could possibly contain the designated location. Particularly, if the emitter 210 is still sensed during the First Stage (as would be the case in FIG. 5A), it is determined that the designated location is in one of the translucent regions 25. Accordingly, in FIG. 5A, quadrants II and IV would be selected as the candidate quadrants. Conversely, if the emitter 210 is no longer sensed (as would be the case in FIG. 5B), it is determined that the designated location is in one of the opaque quadrants. Thus, in FIG. 5B, quadrants I and III would be selected as the candidate quadrants.

After the First Stage, FIGS. 5A and 5B shows that the process continues to a “Second Stage” in which only 25% of the operative portion is translucent, while the remainder is opaque. Particularly, during the Second Stage, an arbitrary one of the candidate quadrants (determined in the First Stage) is chosen to be a translucent region 25 by the LC layer controller 92, while the remainder of the operative portion is made opaque. For example, in FIG. 5A, quadrant IV is chosen to be a translucent region 25; in FIG. 5B, quadrant III is chosen as the translucent region 25. Thus, based on whether or not the emitter 210 is being sensed by light sensing device 80 during the Second Stage, the location of the emitter 210 can be narrowed down to a particular one of the candidate quadrants. For instance, if the light sensing device 80 cannot sense the light rays from emitter 210 during the Second Stage (e.g., the situation in FIG. 5A), the location determining unit 94 selects the opaque candidate quadrant (e.g., quadrant II in FIG. 5A) as the quadrant containing the designated location. However, if the light sensing device 80 does sense the light rays from emitter 210 during the Second Stage, the location determining unit 94 selects the translucent candidate quadrant (e.g., quadrant III in FIG. 5B) as the quadrant containing the designated location. Thereafter, the selected candidate quadrant may be designated as the new search area 28. Thus, quadrant II in FIG. 5A and quadrant III in FIG. 5B are labeled as “28,” thereby showing that they are being designated as the new search area in the respective examples.

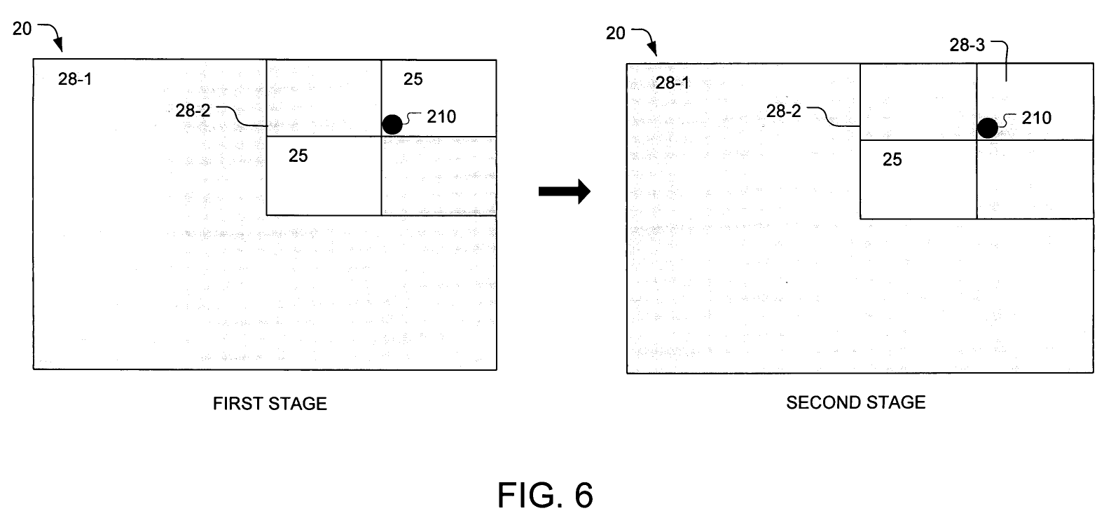

This process may then be recursively applied to the new designated search area 28. Accordingly, the process illustrated in FIGS. 5A and 5B may be considered a first iteration of the recursive process, in which the operative portion is designated as the initial search area. FIG. 6 further illustrates how the process is applied recursive to the new search area 28.

Particularly, FIG. 6 illustrates the process being recursively applied to the situation of FIG. 5A. In FIG. 6, the label “28-1” indicates that the operative portion was the search area initially designated for the first iteration in FIG. 5A. Further, since quadrant II of FIG. 5A was designated as the new search area 28 in the example described above, quadrant II is labeled “28-2” in FIG. 6 to indicate that it has been designated the new search area for the second iteration.

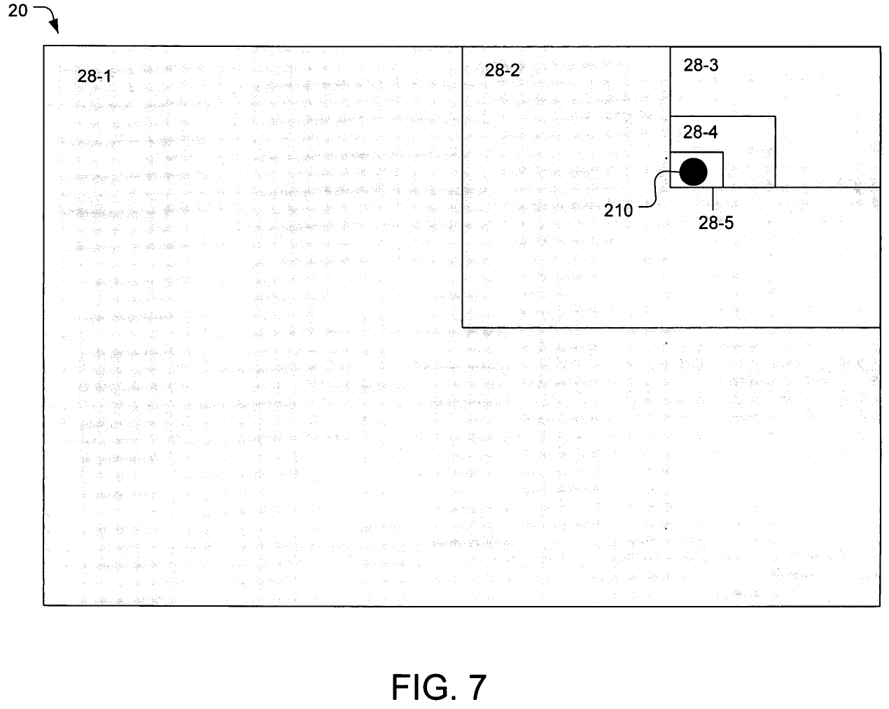

As shown in FIG. 6, during the second iteration of the recursive process, the First and Second Stages are applied to search area 28-2. The result of this, in accordance with the principles described above in connection with FIG. 5A, is that the location of emitter 210 is tracked down even further, and a new search area 28-3 is designated for the next (third) iteration. As shown in FIG. 7, this recursive process may continue until the emitter 210 is tracked down to a small enough region (e.g., area 28-5 in FIG. 7).

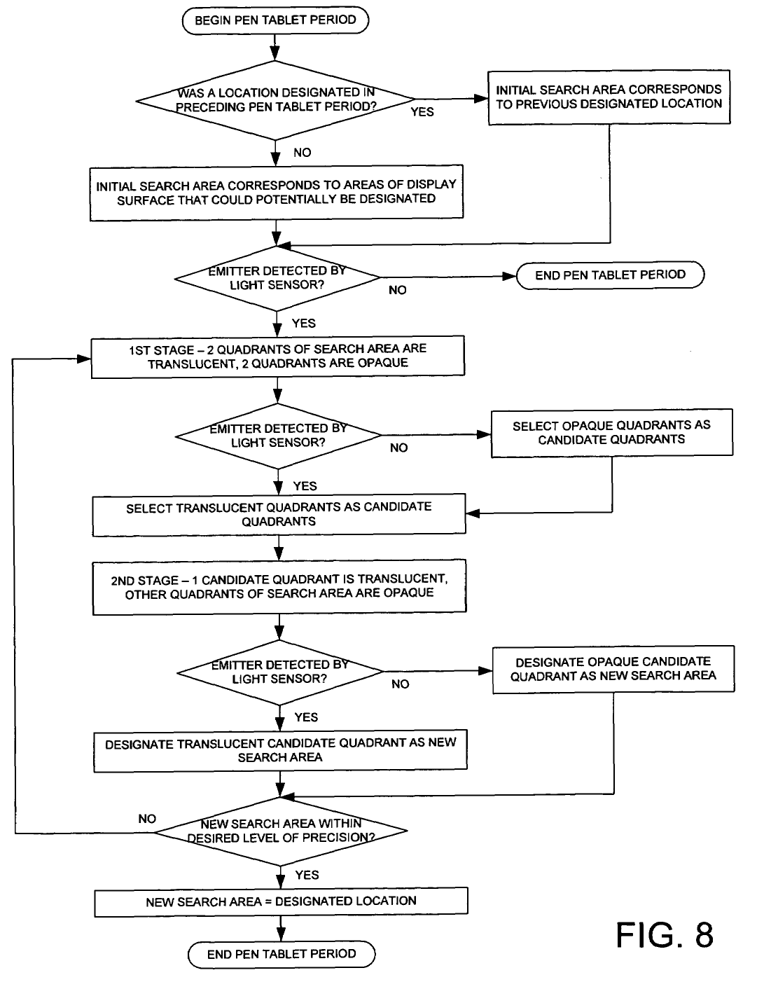

FIG. 8 provides a flow diagram illustrating the steps in a recursive process for tracking down the designated location to within a desired level of precision, as described above in connection with FIGS. 5A&B, 6, and 7.

FIG. 8 illustrates a particular embodiment where the recursive process is continuously performed to convergence, during each pen tablet period. In other words, in FIG. 8, the search process converges to the desired level of precision between each pair of consecutive LCD frames. However, it is not necessary to perform this process to convergence during each pen tablet period. For example, according to an alternative embodiment, a single iteration of the recursive process may be performed during each pen tablet period. Thus, several LCD frame and pen tablet periods would pass before the designated location is found within a particular level of precision. The number of iterations to be performed during each pen tablet period may change according to various design/performance parameters.

In the exemplary embodiment described above in connection with FIGS. 5A&B and 6-8, a search may be performed on the LC layer by successively making 100% of the operative portion translucent, then 50% translucent, then 25% translucent, the 12.5% translucent, and so on, until the location of the emitter 210 is tracked down to a desired level of precision.

For example, assume that the location of the emitter 210 on the display surface (i.e., the location being designated via input device 200) is to be determined within an M-by-M pixel block of accuracy. Further, assume that the display surface is defined by 2ⁿ such pixel blocks along the horizontal axis and 2ⁿ such pixel blocks along the vertical axis. For the pen tablet period in which the input device 200 is initially detected, it would take at most 2n+1 steps to determine the designated location on the display surface. Thus, if the designated location is to be determined within one pixel, in a 60 Hz LCD device 100 with a display surface covering 1024-by-1024 pixels, it should take at most 0.3 seconds (31 pen tablet periods) to find the designated location within the desired precision.

Exemplary embodiments having been described above, it should be noted that such descriptions are provided for illustration only and, thus, are not meant to limit the present invention as defined by the claims below. Any variations or modifications of these embodiments, which do not depart from the spirit and scope of the present invention, are intended to be included within the scope of the claimed invention.

What is claimed is:

1. A liquid crystal display (LCD) device comprising:
a liquid crystal (LC) layer configured to control the passage of light therethrough in order to display information on a display surface; and
a light sensing device configured to sense light rays emitted through the LC layer from an external light source,
wherein a location designated by the external light source on the display surface is determinable based on the sensing operation of the light sensing device.

2. The LCD device of claim 1, further comprising:
a location determiner unit configured to determine the designated location based on the operative state of the LC layer at the time the light rays from the external light source are sensed by the light sensing device.

3. The LCD device of claim 1, wherein the light sensing device is configured to sense light rays in the infrared (IR) range.

4. The LCD device of claim 1, further comprising an LC layer controller configured to control the LC layer such that, during pen tablet mode, an operative portion of the LC layer is divided into translucent and opaque regions in order to determine the designated location.

5. The LCD device of claim 4, wherein, during the pen tablet mode,
the LC layer controller sets the LC layer to a default state of opacity, while causing a translucent opening to scan the operative portion of the LC layer, and
the designated location is determined based on the scan location of the translucent opening as the light rays are sensed by the light sensing device.

6. The LCD device of claim 4, wherein, during a particular instance of the pen tablet mode, the LC device is configured to:
set the LC layer in an initial state for initial detection of the external light source to designate the location, and
in response to the initial detection of the external light source, recursively designate search areas in the LC layer to find the designated location.

7. The LCD device of claim 6, wherein, during the particular instance, the operative portion is defined as a region of the LC layer previously designated as a search area during a previous instance of the pen tablet mode.

8. The LCD device of claim 6, wherein
the LC layer controller sets the LC layer in the initial state by making the operative portion of the LC layer translucent, and
the light sensing device initially detects the external light source by sensing light rays from the external light source while the LC layer is in the initial state.

9. The LCD device of claim 6, wherein, in response to the initial detection of the external light source, the LCD device is configured to designate the operative portion of the LC layer as the initial search area in the LC layer and perform the following recursive process:
logically divide the search area into quadrants,
set the LC layer in a first state where two quadrants in the search area are translucent, while the rest of the operative portion is opaque,
select two quadrants in the search area as candidate quadrants based on the operation of the light sensing device while the LC layer is in the first state,
set the search area in a second state where one of the candidate quadrants is translucent, while the rest of the operative portion is opaque,
select one of the candidate quadrants based on the operation of the light sensing device while the LC layer is in the second state, and
designate the selected candidate quadrant as the next search area.

10. The LCD device of claim 9, wherein the recursive process is repeated until the size of the next designated search area is consistent with a desired precision for determining the designated location.

11. The LCD device of claim 4, wherein LCD device is configured to interleave the pen tablet mode with an image display mode.

12. The LCD device of claim 11, further comprising a backlight source,
wherein operation of the backlight source is limited in accordance with the interleaved modes.

13. A system including the LCD device of claim 1, and further comprising a stylus device configured to emit the light rays through the LC layer.

14. The system of claim 13, wherein the stylus device includes a modulated light emitter, and the light sensing device is configured to demodulate light rays emitted by the modulated light emitter.

15. The system of claim 14, wherein the modulated light emitter is a light-emitting diode (LED).

16. A process in a liquid crystal display (LCD), which is configured to display information on a display surface by controlling the passage of light through a liquid crystal (LC) layer, the device comprising:
sensing light rays emitted through the LC layer from an external light source,
determining a location on the display surface, which is being designated by the external light source, based on the sensing operation of the light sensing device.

17. The process of claim 16, further comprising:
operating the LCD device according to the following interleaved modes: image display mode and pen tablet mode;
during the pen tablet mode, controlling the LC layer such that an operative portion of the LC layer is divided into translucent and opaque regions in order to determine the designated location.

18. The process of claim 17, wherein, during the pen tablet mode, the process further comprises:
setting the LC layer to a default state of opacity;
scanning the operative portion of the LC layer with a translucent opening; and
sensing the light rays from the external light source while the translucent opening scans the LC layer,
wherein the designated location is determinable in accordance with the scan location of the translucent opening when the light rays are sensed.

19. The process of claim 17, wherein, during the pen tablet mode, the process further comprises:
detecting the presence of the external light source;
designating the operative portion of the LC layer as an initial search area; and
performing a recursive process for designating a new search area by manipulating translucent and opaque regions in a previously designated search area.

20. The process of claim 19, wherein each iteration of the recursive process includes:
logically dividing the current search area into quadrants,
setting the LC layer in a first state where two quadrants in the current search area are translucent, while the rest of the operative portion is opaque,
selecting two quadrants in the current search area as candidate quadrants based on the operation of the light sensing device while the LC layer is in the first state,
setting the current search area in a second state where one of the candidate quadrants is translucent, while the rest of the operative portion is opaque,
selecting one of the candidate quadrants based on the operation of the light sensing device while the LC layer is in the second state, and
designating the selected candidate quadrant as the search area for the next iteration.
